(19) United States
(12) Patent Application Publication
(10) Pub. No.: US 2024/0351016 A1
(43) Pub. Date: Oct. 24, 2024

(54) PROCESS FOR DECOMPOSING SIC OR SIC-CONTAINING MATERIALS

(71) Applicant: ALD VACUUM TECHNOLOGIES GMBH, Hanau (DE)

(72) Inventors: Henrik FRANZ, Freigericht (DE); Christoph MORCHE, Aschaffenburg (DE); Ulrich BIEBRICHER, Niddatal (DE); Dieter KAUFHOLD, Großkrotzenburg (DE)

(21) Appl. No.: 18/579,958

(22) PCT Filed: Jul. 8, 2022
(86) PCT No.: PCT/EP2022/069192

§ 371 Date: Jan. 17, 2024

(30) Foreign Application Priority Data
Jul. 23, 2021 (DE) 10 2021 119 205.6

(51) Int. Cl. B01J 38/12; B01J 23/44; B01J 23/96; B01J 27/224; B01J 38/02; C22B 7/00; C22B 11/02

(52) U.S. Cl. CPC B01J 38/12; B01J 23/44; B01J 23/96; B01J 27/224; B01J 38/02; C22B 7/001; C22B 11/026

(57) ABSTRACT

Disclosed is a method for the decomposition of SiC or SiC-containing materials in which the reaction is guided exclusively via gaseous products for achieving a conversion which is as complete as possible. A preferred application is a recycling process for catalyst materials containing platinum metals on a carrier material made of silicon carbide (SiC). In the thermal process, the catalyst materials are freed from the carrier material, and then they can further be refined. (FIG. 1)

The present invention relates to a method for the decomposition of SiC or SiC-containing materials in which the reaction is guided exclusively via gaseous products for achieving a conversion which is as complete as possible. A preferred application is a recycling process for catalyst materials containing platinum metals on a carrier material made of silicon carbide (SiC). In the thermal process, the catalyst materials are freed from the carrier material.

### PRIOR ART

In technology, for diverse reactions catalysts are used for accelerating them or for making them possible in the first place. Normally, for this purpose they are applied onto a carrier material, most often in a thin layer for, on the one hand, increasing the surface useable for reactions and therewith, on the other hand, reducing at the same time the required amount of expensive catalyst metal. Furthermore, with the application onto a carrier material the mechanical strength of the catalyst is increased. In addition, it is easier to handle the carried catalysts and to apply them in chemical reactors and to protect them from undesired discharge. In the case of exhaust-gas catalytic converters for combustion motors or plants the carrier structures make their use possible in the first place, because the channel structures generated with them which are plated with the catalyst metal only actually allow an efficient flowing through of the exhaust gas and contacting with the catalyst metal.

As carrier materials especially ceramic materials have proven their worth because they are characterized by a mechanic stability and inertness at the required reaction conditions. In particular, silicon carbide (SiC) is increasingly used as a catalyst carrier material. A recycling of these catalyst materials is an interesting issue due to several reasons. On the one hand, often, the applied catalytically active material due to its rareness or difficult production is an expensive or even very expensive metal. Examples therefor are in particular the often-used platinum metals.

With platinum metals which in English usage are also known under the designation platinum group metals (PGM) or platinum group elements (PGE) the elements of the groups 8 to 10 of the 5^{th} and 6^{th} periods of the periodic table are meant. Thus, they comprise the noble metals ruthenium (Ru), rhodium (Rh), palladium (Pd), osmium (Os), iridium (Ir) and platinum (Pt).

On the other hand, during the working-up with a clever reaction guidance also economically interesting by-products besides the recovered catalyst materials can be obtained. So, for example, it is possible to crystallize out particularly pure silicon which finds buyers in the semiconductor industry. But the amounts achieved till today are still quite moderate so that the recycling is conducted predominantly from the point of view of the recovery of the catalyst metals.

As is generally also usual in the case of heterogeneous catalysis, in particular in the case of oxidative gas-solid-reactions, in the exhaust-gas catalytic converters for automobiles as carrier materials predominantly ceramic materials are used. In the case of the catalytic converters for gasoline engines which have been installed since the early nineties normally cordierite is used. For recycling, this magnesium aluminosilicate ceramic can very well be melted in electric high-temperature furnaces. The melting is conducted under reducing conditions. Here, the ceramic under oxygen release is separated from the noble metals which are bonded in a so-called collecting metal and obtained in high yields.

The carrier material of a diesel particulate filter (DPF) for diesel engines is substantially different from the one for gasoline engines. Normally, in the case of diesel particulate filters the carrier material consists of SiC. In the recycling, this material requires a substantially different melting process than the cordierite. Here, under oxygen addition an oxidizing melting is conducted for converting the carbon of the carbide into carbon dioxide. Only after this, an efficient recovery of noble metals is possible.

Problems during the process of recycling do not only occur, when both catalyst types for gasoline engines and diesel particulate filters are mixed, which nearly becomes impossible, or at least however uneconomic, when more than a certain concentration of foreign material is contained, but also in the case of diesel particulate filters alone. In the process of working-up of the diesel particulate filters at temperatures starting from about 800° C. in the oxidizing atmosphere on the silicon carbide a glassy coating made of SiO₂ is formed which decelerates and even finally completely disrupts the further reaction. For responding to this passivation of the surface, very high temperatures of considerably higher than 1,700° C. are used which are above the melting point of SiO₂ (1,710° C.) for oxidizing the silicon carbide in the oxidizing atmosphere and for being able to melt it together with the catalyst metal. This means a considerable expenditure of energy.

However, avoiding the formation of SiO₂ is difficult. One approach in this connection is the use of a low partial pressure of oxygen in the reaction room by gas mixtures poor in oxygen. This results in the formation of gaseous SiO instead of the glassy SiO₂. But here, in practice, it cannot be avoided that on the SiC carrier materials a partial pressure of oxygen which is too high arises and nevertheless SiO₂ is also formed which passivates the surface. In addition, the reaction times are increased, when so little oxygen is offered.

In the document DE 43 05 647 A1, a method for the recovery of valuable metals from used exhaust-gas catalytic converters is described which follows a contrary approach, because not the carrier material is separated, but the noble metals. For this purpose, the optionally comminuted catalytic converter material is mixed with an alkali chloride and heated in a revolving cylindrical furnace in an atmosphere of chlorine at temperatures of 350° C. to 700° C. for 0.2 h to 3 h. So, a direct conversion into the water-soluble hexachloro compounds of the platinum metals is achieved. The discharged reaction mass is then extracted with water and hydrochloric acid and the extract is further processed in the normal manner. In this method, the carrier material of the catalytic converter is not changed and thus, it can even be used again. Only the valuable metals are brought into solution.

This is a modified form of the reaction of the material to be worked up with chlorine gas and/or hydrogen chloride gas at increased temperatures. In contrast to pyrometallurgic methods, the reaction temperatures are lower and no slag is generated. But, however, it is necessary to conduct a laborious working-up of the reaction product using wet chemical methods and to use an aggressive atmosphere of chlorine.

The document EP 0 767 243 B1 discloses a method for the recovery of active components from carrier catalysts or bulk catalysts by reaction with a substantially water-free hydrogen halide and optionally fractional separation. In said method, also while maintaining the catalyst material in its original form, it is reacted with substantially water-free hydrogen halide at 20° C. to 900° C. and a pressure of 0.01 bar to 10 bar in a cylindrical furnace. In the case of, for example, platinum and palladium this is realized in the absence of oxygen. As suitable carrier materials for the catalyst inter alia also SiC is mentioned. Preferably, it is worked under normal pressure and at 150° C. to 700° C. The chlorides formed can either be discharged in gaseous form or can also be solubilized with acids. The hydrogen halide gas is preferably diluted with an inert gas, preferably with nitrogen. Thus, also here, the serious disadvantages that subsequently a working-up using wet chemical methods has to be conducted for obtaining the platinum metals and that it is necessary to work in an aggressive atmosphere of hydrogen chloride exist.

Thus, the methods of prior art have in common that in the case of the separation of the platinum metals from the SiC carrier material they require a laborious working-up using wet chemical methods and reactions in the gas phase at increased temperatures with aggressive chlorine or hydrogen chloride gas. On the other hand, in the case of the separation of the SiC carrier material from the platinum metals very high temperatures are necessary, which results in a high energy demand, or very long reaction times.

### OBJECT

Therefore, the object of the present invention was to provide an improved method for the decomposition of SiC or SiC-containing materials which is not impaired by the disadvantages of prior art. When the method for the separation of platinum metals from catalyst materials is used, then, in particular it should be possible to achieve for their catalyst carrier materials based on SiC a nearly residue-free separation of the SiC carrier material from the platinum metals and thus a method which is as economical as possible.

### DESCRIPTION OF THE INVENTION

This object is solved by a method according to claim 1. Advantageous embodiment variants are the subject matter of the dependent claims.

According to the present invention is a method for the decomposition of SiC or SiC-containing materials, wherein
the SiC or SiC-containing material and an additive in the form of one or several oxygen-containing compounds with the exception of oxygen are fed into a reactor under reduced pressure;
temperature and pressure in the reactor are adjusted such that the equilibrium partial pressure of oxygen in the reactor is
   lower than the partial pressure of oxygen in the oxygen-containing compound so that an equilibrium reaction of the oxygen-containing compound to the oxygen-containing compound in a lower oxidation state and oxygen is shifted towards the formation of the oxygen-containing compound in a lower oxidation state and oxygen, and
   lower than the partial pressure of oxygen in the SiO₂ which is formed from the SiC by oxidation with the oxygen of the additive so that the formation of condensed SiO₂ on the surface of the SiC is avoided; and
for the oxidation of the SiC exclusively oxygen in the form of the additive is added.

According to the present invention, the conditions of the method are selected such that the formation of the passivating SiO₂ layer on the SiC or SiC-containing material is avoided and that a nearly complete transfer of the silicon carbide into the gas phase is realized. Here, the silicon carbide is oxidized by the oxygen-containing compound, wherein at the reaction conditions nearly exclusively gaseous products are generated which due to the reduced pressure are quickly removed from the surface. Since the formed volatile reaction products leave the reaction areas via the gas phase, no kinetic inhibition of the progress of the reaction by deposits of reaction products takes place. The reaction can be controlled via the partial pressures of oxygen of the reaction partners which can be influenced by the temperature, the pressure and the partial pressure of oxygen in the reactor.

Here, the equilibrium reaction of the oxygen-containing compound into its reduced form and oxygen is shifted in a targeted manner onto the side of the oxygen release by the adjustment of a partial pressure of oxygen which is lower in the reactor than in the oxygen-containing compound which is realized by means of a selection of suitable pressures and temperatures in the reactor. At the same time, the partial pressure of oxygen in the reactor has to be lower than the one in the SiO₂ which is formed from the SiC by oxidation with the oxygen being released such, so that the equilibrium reaction of the SiO being formed in the first step from the SiC with further oxygen to the SiO₂ is shifted onto the side of the SiO. To this, further explanations can also be found below.

It is essential for the present invention that no elementary oxygen is added in the form of a gas into the reactor, but that the oxygen which is required for the oxidation of the SiC is exclusively generated by the decomposition equilibriums of the oxygen-containing compound added. In the case of the SiC-containing materials, additional oxygen can be generated by the decomposition of these further materials. So, for example, catalyst carrier materials based on SiC besides the SiC can also contain additional substances such as SiO₂, Al₂O₃ or other oxides which under the method conditions are also able to release oxygen. According to the present invention, this is also envisaged.

Particularly preferably, the partial pressure of oxygen in the reactor is less than 10⁻¹³ hPa. It, for example, can be less than 1·10⁻¹⁴ hPa, less than 2·10⁻¹⁴ hPa, less than 3·10⁻¹⁴ hPa, less than 4·10⁻¹⁴ hPa, less than 5·10⁻¹⁴ hPa, less than 6·10⁻¹⁴ hPa, less than 7·10⁻¹⁴ hPa, less than 8·10⁻¹⁴ hPa, or less than 9·10⁻¹⁴ hPa. It can be at least 1·10⁻¹⁶ hPa, at least 2·10⁻¹⁶ hPa, at least 3·10⁻¹⁶ hPa, at least 4·10⁻¹⁶ hPa, at least 5·10⁻¹⁶ hPa, at least 6·10⁻¹⁶ hPa, at least 7·10⁻¹⁶ hPa, at least 8·10⁻¹⁶ hPa, or at least 9·10⁻¹⁶ hPa. In particular, the partial pressure of oxygen in the reactor is 10⁻¹⁶ hPa≤p(O₂)<10⁻¹⁵ hPa, hPa≤p(O₂)<10⁻¹³ hPa, or 10¹⁴ hPa≤p(O₂)<10⁻¹³ hPa.

In a particularly preferred embodiment variant, the SiC-containing material comprises catalyst carrier materials. In an especially preferred embodiment variant, the SiC-containing material further comprises platinum metals and a separation of the platinum metals from the catalyst carrier materials is conducted. In such methods after the evaporation of the SiC carrier materials the platinum metals remain as accumulating residues. In an optional subsequent step, then they still can further be purified according to the requirements, or, in the case of mixtures of platinum metals in the catalyst, they can be separated from each other.

In embodiment variants, the pressure in the reactor is preferably 0.001 hPa to 900 hPa, more preferably 0.01 hPa to 800 hPa, more preferably 0.02 hPa to 700 hPa, more preferably 0.03 hPa to 600 hPa, more preferably 0.04 hPa to 500 hPa, more preferably 0.05 hPa to 400 hPa, more preferably 0.06 hPa to 300 hPa, more preferably 0.07 hPa to 250 hPa, more preferably 0.08 hPa to 200 hPa, more preferably 0.09 hPa to 150 hPa, most preferably 0.1 hPa to 100 hPa. The pressure in the reactor can in particular preferably be at least 0.001 hPa, more preferably at least 0.01 hPa, more preferably at least 0.02 hPa, more preferably at least 0.03 hPa, more preferably at least 0.04 hPa, more preferably at least 0.05 hPa, more preferably at least 0.06 hPa, more preferably at least 0.07 hPa, more preferably at least 0.08 hPa, more preferably at least 0.09 hPa, most preferably at least 0.1 hPa. In particular, the pressure in the reactor can preferably be at most 900 hPa, more preferably at most 800 hPa, more preferably at most 700 hPa, more preferably at most 600 hPa, more preferably at most 500 hPa, more preferably at most 400 hPa, more preferably at most 300 hPa, more preferably at most 250 hPa, more preferably at most 200 hPa, more preferably at most 150 hPa, most preferably at most 100 hPa. Via the adjustment of the pressure in the reactor, the equilibrium reaction of the silicon carbide with the oxygen-containing compounds can be controlled in a targeted manner.

The temperature onto which the SiC or SiC-containing material and the additive are heated can be from 1,000° C. to 1,650° C., preferably from 1,100° C. to 1,625° C., more preferably from 1,200°° C. to 1,600° C., most preferably from 1,300° C. to 1,600° C. In particular, the temperature can preferably be at least 1,100° C., more preferably at least 1,150° C., more preferably at least 1,200° C., more preferably at least 1,250° C., most preferably at least 1,300° C. In particular, the temperature can preferably be at most 1,625° C., most preferably at most 1,600° C. or 1,550° C. This temperature range has shown to be advantageous, because in this range an optimum of reaction rate, thermal load of the reactor, required pressure reduction and shifting of the equilibrium onto the side of the gaseous degradation products is achieved.

In embodiment variants, the oxygen-containing compound is selected from the group consisting of CO₂, H₂O and a metal oxide or metalloid oxide. Particularly preferred are metal oxides and metalloid oxides which at the reaction conditions can form gaseous suboxides.

In embodiment variants, the metal oxide or metalloid oxide between 1,300° C. and 1,700° C. has an equilibrium partial pressure of oxygen of ≤10⁻¹¹ hPa. It may be, for example, ≤1·10⁻¹² hPa, ≤2·10⁻¹² hPa, ≤3·10⁻¹² hPa, ≤4·10⁻¹² hPa, ≤5·10⁻¹² hPa, ≤6·10⁻¹² hPa, ≤7·10⁻¹² hPa, ≤8·10⁻¹² hPa or ≤9·10⁻¹² hPa. It may be at least 1·10⁻¹⁴ hPa, al least 2·10⁻¹⁴ hPa, at least 3·10⁻¹⁴ hPa, at least 4·10⁻¹⁴ hPa, at least 5·10⁻¹⁴ hPa, at least 6·10⁻¹⁴ hPa, at least 7·10⁻¹⁴ hPa, at least 8·10⁻¹⁴ hPa, or at least 9·10⁻¹⁴ hPa. In particular, the equilibrium partial pressure of oxygen is 10⁻¹⁴ hPa≤p(O₂)≤10⁻¹¹ hPa, 10⁻¹³ hPa≤p(O₂)≤10⁻¹¹ hPa or 10⁻¹² hPa≤p(O₂)≤10⁻¹¹ hPa.

Preferably, the metal oxide or metalloid oxide is selected from the group consisting of SiO₂ and Al₂O₃.

The mixing ratio based on the mass of SiC-containing material and metal oxide or metalloid oxide may be between 2:1 and 1:2.

The reaction equations of the equilibrium reaction of the silicon carbide with the oxygen-containing compounds are for SiO₂ and Al₂O₃, for example:

$$SiC + 2 {SiO}_{2} ⇌ CO + 3 SiO \qquad ( equation 1 )$$

$$SiC + {Al}_{2} {O}_{3} ⇌ CO + {Al}_{2} O + SiO \qquad ( equation 2 )$$

As can easily be seen, the equilibrium can be shifted onto the right side each by pressure reduction.

The formation of volatile suboxides thermodynamically depends on the partial pressure of oxygen in the reactor and this partial pressure in turn is determined in the present case by the gas equilibrium of CO/CO₂. This equilibrium in the presence of carbon or, as in the present case, carbon-containing substances is quantitatively described by the known Boudouard equilibrium.

$${CO}_{2} + SiC ⇌ 2 CO + Si \qquad ( equation 3 )$$

The connection of the partial pressures of carbon monoxide, carbon dioxide and oxygen is described, exemplarily, in the following equation.

$${CO}_{2} ⇌ CO + 1 / 2 {O}_{2} \qquad ( equation 4 )$$

According to the thermodynamic data of the free enthalpies, the equilibrium partial pressures are as follows:

$${K}_{4} = \frac{{p}_{CO}}{{p}_{{CO}_{2}}} \sqrt{{p}_{{O}_{2}}}$$

$$or$$

$${p}_{{O}_{2}} = \frac{{p}_{{CO}_{2}}^{2} {K}_{4}^{2}}{{p}_{CO}^{2}}$$

With equilibriums of CO/CO₂ being very strongly shifted to carbon monoxide by suitable boundary conditions (high temperatures, low pressures), very low partial pressures of oxygen in the [symbol] reaction room can be realized. The partial pressure ratio P_{CO}/P_{CO}_{₂} depends on the pressure and the temperature. At 1,500° C. and a total pressure in the reactor room of ca. 1 hPa, for example, the equilibrium partial pressures of CO₂, CO and O₂ of P_{CO2}=9·10⁻⁸ hPa, p_{CO}≈1 hPa and p_{O2}=2·10⁻¹⁹ hPa result. At the same conditions, the partial pressure of oxygen in the silicon dioxide is p_{O2(in SiO2)}=3·10⁻¹⁵ hPa.

For avoiding the formation of silicon dioxide during the reaction, in the method according to the present invention the conditions at the reaction front are designed such that the partial pressure of oxygen at this point is considerably lower than the equilibrium partial pressure of the oxygen in the silicon dioxide which corresponds to the reaction conditions each. In this manner, only gaseous reaction products are generated (silicon monoxide, carbon monoxide) which escape at the reaction front and do not impede the reaction progress.

Such a reaction guidance according to the present invention, as exemplarily shown for SiO₂ and Al₂O₃ (see equations 1 and 2), can be used for all oxygen-containing compounds which form volatile suboxides and/or are gaseous. An example for a gaseous oxygen-containing compound is CO₂ according to the overall reaction equation shown below.

$$SiC + 2 {CO}_{2} ⇌ 3 CO + SiO \qquad ( equation 5 )$$

In FIG. 1, the partial pressure diagram of oxygen for different process conditions is plotted. Here it is assumed that the pressure in the reactor relates to the sum of the partial pressures of carbon monoxide, carbon dioxide, oxygen and silicon monoxide. Shown is the partial pressure of oxygen for the two reactions

$$SiC + {O}_{2} ⇌ {SiO}_{2} + C \qquad ( reaction I )$$

$$Si + {O}_{2} ⇌ {SiO}_{2} \qquad ( reaction II )$$

and the corresponding reactor pressure. The difference in the partial pressures of oxygen directly correlates with the free enthalpy of the reaction towards the silicon monoxide according to equation 7 and is a measure for the avoidance of the formation of SiO₂.

$${SiO}_{2} ⇌ SiO + 1 / 2 {O}_{2} \qquad ( equation 7 )$$

In the plotting, it can clearly be seen that at temperatures which are considerably lower than 1300° C. the partial pressure of oxygen in the silicon dioxide is so low that, for decomposing SiO₂, it would be necessary to lower the total pressure in an extremely laborious manner.

It also becomes clear that at higher temperatures the decomposition of the silicon dioxide is shifted to higher partial pressures of oxygen. So, as a consequence, also higher process pressures can be realized. However, higher process temperatures always come along with the increase of the power loss and a heavier load on the plant.

The SiC or SiC-containing material can be fed into the reactor in ground, crushed and/or not treated form. The designation “not treated” in this connection relates to a not conducted mechanical comminution of the SiC or SiC-containing material, and thus can be understood as a synonym for “not mechanically comminuted”. Here, the pros and cons have to be balanced, whether the gain in surface caused by grounding or crushing into a powder or granules and the thereby increased reaction rate justify the additional preparation step. In the case of solid oxygen-containing compounds grinding or crushing are particularly advantageous for allowing mixing with them. Here, the particle size, for example, for a powder may be in the range of 10 μm to 100 μm, and for crushed granules in the range of 100 μm to 20 mm. In the case of gaseous oxygen-containing compounds also without problems the not treated SiC or SiC-containing material can be used. Furthermore, this also depends on the kind of the SiC or SiC-containing material. For large catalysts such as diesel particulate filters there is rather a tendency that they should be comminuted, whereas catalysts for chemical plants which most often are already small-sized can go without further comminution.

Preferably, the reaction is conducted in a continuously working reactor. In particular in the case of the use of small-sized SiC or SiC-containing materials and solid oxygen-containing compounds a continuously working reactor is advantageous, because here a mixing and transport function can easily be integrated and thus the times for charging a batch plant can be avoided. In the case of the larger diesel particulate filters, however, also a batchwise processing, for example in a vacuum furnace, with gaseous oxygen-containing compounds can be realized.

Preferably, the reactor is a revolving cylindrical furnace, continuous furnace, fluidized bed reactor or a flatbed furnace. It is most preferred, when as a continuous furnace a pusher-type furnace is used. The latter is particularly suitable for the economical processing of not comminuted catalysts in a continuous process.

In the case of these reactor types, the reaction time is preferably between 0.25 hours and 10 hours. It may, for example, be between 0.5 hours and 9.5 hours, between 0.75 hours and 9 hours, between 1 hour and 8.5 hours, between 1.5 hours and 8 hours, between 2 hours and 7.5 hours or between 2.5 hours and 7 hours. Depending on the reactor type used and the particle size used, the reaction time can be adjusted. When much heat is introduced into powdery material, as it is possible in the case of a fluidized bed reactor, short reaction times can be realized. When as starting material, for example, a not comminuted diesel particulate filter is selected, which should be treated in a vacuum furnace, then correspondingly longer reaction times are required.

In embodiment variants, the heating is realized by thermal radiation, in particular of graphite, SiC or metallic heaters, or microwave radiation. These heating variants have the advantage that with them also at reduced pressure in the reactor an efficient heating of the material is guaranteed.

In a further embodiment variant, the reactor is a plasma burner.

The reaction time for this reactor type is preferably between 0.1 second and 5 seconds. It can, for example, be between 0.2 seconds and 4.5 seconds, between 0.3 seconds and 4 seconds, between 0.4 seconds and 3.5 seconds, between 0.5 seconds and 3 seconds, between 0.75 seconds and 2.5 seconds or between 1 second and 2 seconds. With the extremely high temperature in the plasma and the high introduction of heat into the powdery material, extremely short reaction times can be realized.

In a preferred embodiment variant, the heating is realized in a plasma burner into which the SiC or SiC-containing material and the additive are fed, and the reaction directly takes place in the plasma flame. Plasma burners can also be operated with reduced pressure. Via the generated plasma, easily and efficiently, a large amount of heat can be transmitted to the SiC or SiC-containing material. This allows a high throughput with extremely short reaction times. Here, the SiC or SiC-containing material and the additive have to be provided in ground form as a powder so that they can be fed into the plasma burner together with the burnable gas. This process guidance has the advantage that a particularly small plant size can be realized.

Preferably, here furthermore as an oxygen-containing compound H₂O can be used and can be fed into the plasma burner together with a hydrocarbon. For the adjustment of the low partial pressures of oxygen, then it is reverted to the equilibrium water/hydrogen according to the reaction equation

$${H}_{2} O ⇌ {H}_{2} + 1 / 2 {O}_{2} . \qquad ( equation 7 )$$

In embodiment variants, the mass loss of the SiC or SiC-containing material can be at least 65%, preferably at least 70% or at least 75% or at least 80% or at least 85% or in particular at least 90%, based on the SiC portion. In embodiment variants, the mass loss can be at most 99.5% or at most 99% or at most 98% or at most 97%.

### SHORT DESCRIPTION OF THE FIGURE

FIG. 1 shows the partial pressure diagram of oxygen for different process conditions.

FIG. 2 shows the particle size distribution of the SiC-containing starting material of example 1.

FIG. 3 shows the particle size distribution of the SiC-containing starting material of example 2.

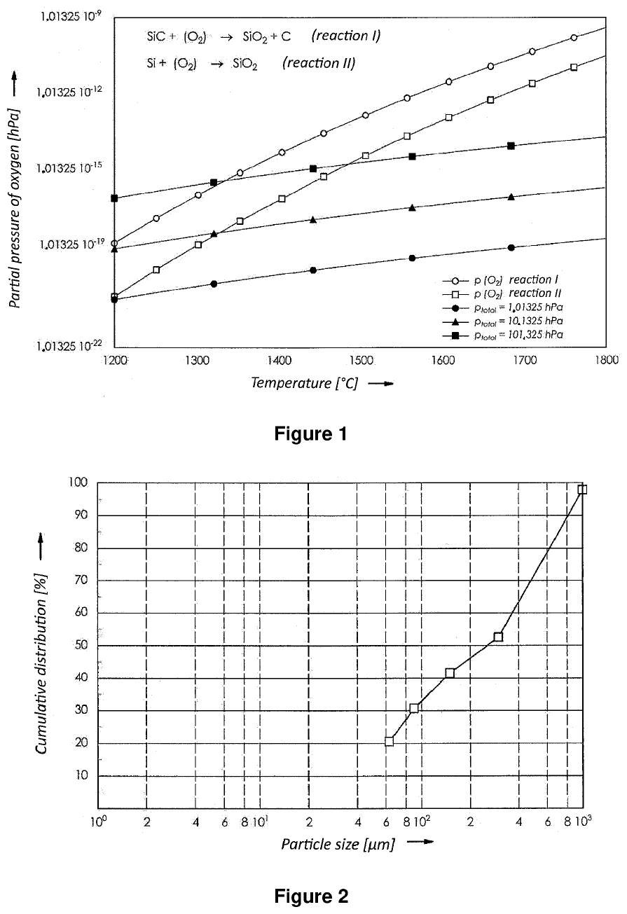

### EXAMPLES

The particle size distributions of the ground materials were determined with a sieve analysis on the basis of the DIN 66165-2:2016-08 in a sieve stack of the company RETSCH, model AS200 control. The work was conducted without a separation of the fine fraction prior to the sieving and with an amplitude of 0.7 mm/“g”, a sieving time of 20 min and an interval time of 1 s.

### 1. Flatbed Furnace

The SiC-containing material for this example consisted of a catalyst material from a diesel particulate filter comprising an SiC-based carrier material and an active coating with the platinum metals platinum and palladium. It was comminuted in a screen ball mill to the particle size distribution shown in FIG. 2. Subsequently, it was mixed with DORSILIT sand (SiO₂ content 99.1% by weight) in the mixing ratio based on the mass of 1:1 and added into an Al₂O₃ crucible. The SiC portion of the starting material was ca. 80% by weight (based on the catalyst material).

In a vacuum furnace consisting of a water-cooled steel chamber and a treatment zone equipped with graphite heaters, the mixture in the Al₂O₃ crucible was reacted at a treatment temperature of 1,540° C. and a treatment duration of 3.5 h. The starting mass (however based on the total mixture of catalyst material and sand) was reduced by 90%. During the process the mean pressure in the reactor was 0.9 hPa. A subsequently conducted chemical analysis showed an enrichment of the platinum by the factor of 10.3. For palladium, an enrichment by the factor of 9.8 was shown. The chemical analyses were consistent with the mass balance. For CO as a gaseous product occurring during the process an unambiguous identification by means of mass spectroscopy was possible. In a filter downstream in the plant an SiO-containing residue was identified.

### 2. Plasma Burner

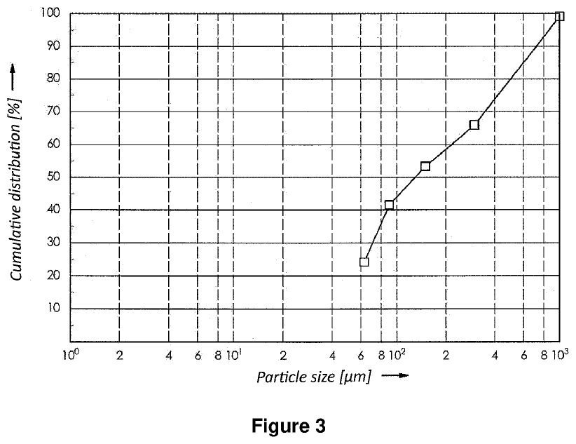

A similar SiC-containing material of a catalyst material originating from a diesel particulate filter such as in example 1 was comminuted in a screen ball mill to the particle size distribution shown in FIG. 3. Subsequently, together with an Ar/CO₂/H₂ mixture (ca. 50% by volume of Ar, 45% by volume of CO₂ and 5% by volume of H₂) it was directly transported through and reacted by a plasma burner. The plasma burner worked with a chamber pressure of between 0.5-10 hPa. Based on analogous experiments, the reaction time of the raw material in the plasma zone was determined to be between 0.1 and 0.5 seconds. Direct measurements of the temperature in the plasma zone were not conducted, however, with the chosen configuration and the process parameters plasma temperatures which are considerably higher than 10,000 K can be expected. Prior to the experiment, a characteristic spectrum of the chemical composition of the raw material was recorded, and this one was compared with the spectrum of the product. This showed a reduction of the SiC by 70% (based on the original SiC content in the catalyst material). The chemical analysis of the product by means of mass spectrometry with inductively coupled plasma (ICP-MS) showed an enrichment by the factor 7.3 for platinum and 6.6 for palladium.

1. A method for decomposing SiC or SiC-containing materials, comprising:
feeding the SiC or SiC-containing material and an additive into a reactor under reduced pressure, wherein the additive is one or more oxygen-containing compounds excluding molecular oxygen;
adjusting a temperature and a pressure in the reactor such that an equilibrium partial pressure of oxygen in the reactor is:
lower than a partial pressure of oxygen in the oxygen-containing compound so that an equilibrium reaction of the oxygen-containing compound to the oxygen-containing compound in a lower oxidation state and oxygen is shifted towards a formation of the oxygen-containing compound in a lower oxidation state and oxygen, and
lower than a partial pressure of oxygen in the SiO₂ which is formed from the SiC by oxidation with the oxygen of the additive so that a formation of condensed SiO₂ on a surface of the SiC is avoided;
wherein molecular oxygen is excluded from the reactor.

2. The method according to claim 1, wherein the partial pressure of oxygen in the reactor is lower than 10⁻¹³ hPa.

3. The method according to claim 1, wherein the pressure in the reactor is 0.001 hPa to 900 hPa.

4. The method according to claim 1, wherein the oxygen-containing compound is selected from the group consisting of CO₂, H₂O and a metal oxide or metalloid oxide.

5. The method according to claim 1, wherein the metal oxide or metalloid oxide between 1,300° C. and 1,700° C. has an equilibrium partial pressure of oxygen of ≤10⁻¹¹ hPa.

6. The method according to claim 1, wherein the metal oxide or metalloid oxide is selected from the group consisting of SiO₂ and Al₂O₃.

7. The method according to claim 1, wherein the reaction is conducted in a continuously working reactor.

8. The method according to claim 1, wherein the reactor is a revolving cylindrical furnace, continuous furnace, fluidized bed reactor or a flatbed furnace.

9. The method according to claim 8, wherein a reaction time is between 0.25 hours and 10 hours.

10. The method according to claim 1, wherein the SiC or SiC-containing material and the additive are heated to temperatures of 1,000° C. to 1,650° C.

11. The method according to claim 1, wherein adjusting the temperature is realized by thermal radiation or microwave radiation.

12. The method according to claim 1, wherein the reactor is a plasma burner.

13. The method according to claim 12, wherein a reaction time is between 0.1 seconds and 5 seconds.

14. The method according to claim 12, wherein adjusting the temperature is realized in a plasma burner into which the SiC or SiC-containing material and the additive are fed, and the reaction takes place directly in a plasma flame.

15. The method according to one of claims 12, wherein the oxygen-containing compound is H₂O and fed into the plasma burner together with a hydrocarbon.

16. The method according to claim 1, wherein the SiC or SiC-containing material is fed into the reactor in ground, crushed and/or not treated form.

17. The method according to claim 1, wherein a mass loss of the SiC or SiC-containing material is at least 65% based on the SiC portion.

18. The method according to claim 1, wherein the SiC-containing material comprises catalyst carrier materials.

19. The method according to claim 18, wherein the SiC-containing material further comprises platinum, and the method further comprises separating platinum group metals from the catalyst carrier materials.

20. The method according to claim 11, wherein adjusting the temperature is realized by thermal radiation of graphite heaters, SiC heaters or metallic heaters.
